(19) United States
(12) Patent Application Publication
(10) Pub. No.: US 2018/0266462 A1
(43) Pub. Date: Sep. 20, 2018

(54) CONNECTION ARRANGEMENT, VEHICLE SEAT, METHOD FOR PRODUCING A CONNECTION ARRANGEMENT, AND METHOD FOR CONNECTING TWO COMPONENTS

(71) Applicant: Adient Luxembourg Holding S.à.r.l, Luxembourg (LU)

(72) Inventor: Markus SCHLITT, Overath (DE)

(21) Appl. No.: 15/517,757

(22) PCT Filed: Oct. 13, 2015
(86) PCT No.: PCT/EP2015/073674

§ 371 Date: Apr. 7, 2017

(30) Foreign Application Priority Data
Oct. 14, 2014 (DE) 10 2014 220 797.5

(51) Int. Cl. F16B 5/02; B60N 2/68; F16B 37/02; F16B 5/00

(52) U.S. Cl. CPC F16B 5/02; B60N 2/682; F16B 25/103; F16B 5/0096; F16B 37/02

(57) ABSTRACT

A connection arrangement, that connects a first component (2) to a second component (3), includes a screw (1) with a screw head (10) and a threaded shaft (11) which has an exterior thread (12). The first component includes a mating connection piece (20), which has a support surface (21) and a collar (23). A depression (22) encircles the collar (23) and is formed in the support surface (21). A protrusion (14) is arranged on a screw head lower face (13), facing the collar (23). The protrusion is operatively connected to the depression (22) in the support surface (21) of the mating connection piece (20) in an assembled state of the screw (1), with the interposition of the second component. A vehicle seat (100) includes the first component and the second component, fixed by the connection arrangement. A methods for producing the connection arrangement and for connecting the components are provided.

### CROSS REFERENCE TO RELATED APPLICATIONS

This application is a United States National Phase Application of International Application PCT/EP2015/073674, filed Oct. 13, 2015, and claims the benefit of priority under 35 U.S.C. § 119 of German Application 10 2014 220 797.5, filed Oct. 14, 2014, the entire contents of which are incorporated herein by reference.

### FIELD OF THE INVENTION

The invention relates to a connecting arrangement for connecting a first component to a second component, wherein the connecting arrangement has a screw with a screw head and a threaded shank having an external thread. The invention also relates to a vehicle seat, to a method for producing a connecting arrangement, and to a method for connecting a first component to a second component.

### BACKGROUND OF THE INVENTION

In modern manufacturing, it is important to tighten highly stressed and highly loadable screw connections in such a defined manner that a minimum preload force is achieved in the screw connection. If this minimum preload force is dropped below, the screw connection is underloaded and can loosen. On the other hand, a predetermined maximum preload force must not be exceeded, since otherwise the screw connection is overloaded and can fatigue prematurely or rupture. Therefore, the aim is to achieve as close a tolerance as possible of the preload force that is achieved when the screw connection is tightened.

DE 100 01 857 A1 discloses a generic connecting element in the form of a screw for a screw connection, said connecting element having a protrusion on its bearing face and a surface region located radially further out. The height and cross section of the protrusion are dimensioned such that, while the screw connection is being tightened, the protrusion is deformed elastically or plastically to such an extent that, when a particular preload force is reached, the radially external surface region comes into abutment.

Furthermore, DE 10 2004 020 676 A1 discloses a method and a device for attaching a fastening element to a sheet-metal component, wherein, for a permanent connection, the sheet-metal component is pressed into a recess in a screw or nut by means of a pressing tool in a joining process.

DE 10 2010 047 636 A1 discloses the connecting of a functional element to a larger-diameter flange forming an attachment surface and to a centering portion that is arranged within the attachment surface and extends away from the flange, wherein an adhesive that is curable under pressure is arranged around the centering portion and next to the attachment surface.

DE 84 20 217 U1 discloses a screw having an axially elastic annular flange which is operatively connected to a housing portion to provide a sealed screw passage.

### SUMMARY OF THE INVENTION

The invention is based on an object of providing a connecting arrangement for connecting a first component to a second component, of the type mentioned at the beginning, and providing a corresponding vehicle seat. A further object of the invention is to provide a method for producing a connecting arrangement according to the invention and a method for connecting a first component to a second component.

This object is achieved according to the invention by a connecting arrangement for connecting a first component to a second component, said connecting arrangement having a screw with a screw head and a threaded shank having an external thread. The connecting arrangement also has a first component having a counterpart connecting piece, wherein the counterpart connecting piece has a supporting face and a collar. A depression encircling the collar is formed in the supporting face. A protrusion is arranged on an underside, facing the collar, of the screw head, wherein the protrusion is operatively connected to the depression in the supporting face of the counterpart connecting piece in a fitted state of the screw, in particular with the second component interposed. The operative connection between the protrusion and the depression in the first component can be understood as being in particular the resultant overall effect of an interaction between the protrusion and the second component and an interaction between the second component and the depression in the first component.

Provision can be made for the counterpart connecting piece, in particular the collar and the depression in the supporting face, to have been manufactured by means of a drawing process and/or a stamping process. This results in the advantage that the counterpart connecting piece can already be produced during the manufacturing thereof, preferably in the context of a forming process which gives the counterpart connecting piece a desired final shape, without further necessary complicated work steps and machining operations. In this way, it is advantageously possible not only to save time in the manufacturing of the counterpart connecting piece, but also to minimize the number of manual operations to be carried out by operators of the manufacturing machines. As a result of the latter, it is also possible in particular to advantageously minimize the number of possible sources of error in the manufacturing of the counterpart connecting piece.

According to a further exemplary configuration of the connecting arrangement, the second component is fixable between the screw head and the supporting face. In this case, the pressure force between the second component and the underside of the screw head and between the second component and the supporting face of the counterpart connecting piece of the first component is distributed over a large area and advantageously the preload force of the connecting arrangement is increased. In this case, provision can preferably be made for the second component to be fixable, in particular aligned with the first component and held, by the screw being screwed into the first component, thereby providing a simple possibility of connecting the first component to the second component, this additionally bringing about alignment and centering of the second component around the screw.

Furthermore, the provision of a depression cooperating with a protrusion on the screw produces the advantage that a particularly favorable form fit can be achieved with regard to the tensile forces and/or shear forces, as seen in the transverse direction with respect to the screw. This is facilitated in particular by the lateral engagement of that portion of the second component that is pressed into the depression, and the creation, distributed over an increased surface area, of the form fit.

According to a first exemplary configuration of the connecting arrangement, the counterpart connecting piece is manufactured from a metal sheet. In this case, the use of a shaping method and/or a forming method, in particular a drawing process and/or a stamping process, is particularly advantageously facilitated.

According to a further exemplary configuration of the connecting arrangement, the counterpart connecting piece has, in the region of the formed collar, an internal thread, which preferably cooperates with the external thread of the screw. This creates a simple possibility of setting a required preload force of the connection of the screw to the counterpart connecting piece.

According to a further exemplary configuration of the connecting arrangement, the screw has an external thread, which is designed to cut into an inner surface of the collar of the counterpart connecting piece when the screw is fitted.

According to a further exemplary configuration of the connecting arrangement, in the fitted state of the screw, the protrusion is located opposite the depression in the supporting face, or in other words, the depression in the supporting face is arranged in a manner aligned with the protrusion on the screw head, with the result that the interaction between the protrusion on the screw and the depression in the counterpart connecting piece can be facilitated further.

According to a further exemplary configuration of the connecting arrangement, the protrusion extends coaxially with an axis, in particular a rotation axis of the threaded shank, of the screw.

According to a further exemplary configuration of the connecting arrangement, the protrusion is interrupted in an encircling direction. This creates the possibility of influencing the local load and/or stress on the underside of the screw and on the supporting face of the counterpart connecting piece in a targeted manner such that a greater load can be achieved locally, and also such that load can be relieved locally.

According to a further exemplary configuration of the connecting arrangement, the protrusion extends continuously in an encircling direction. This configuration of the connecting arrangement brings about a particularly uniform distribution of the pressure force in the circumferential direction of the protrusion on the screw.

According to a further exemplary configuration of the connecting arrangement, the protrusion on the underside of the screw head has a contour which is coordinated with a contour of the depression in the supporting face of the counterpart connecting piece. The contour of the protrusion preferably differs in terms of its height and/or its width and/or its radius from the dimensions of the contour of the depression.

According to a further exemplary configuration of the connecting arrangement, provision can also be made here for the second component to have a sectional deformation as a result of the protrusion on the screw head and the depression in the supporting face. This creates the advantage that, on account of inherent rigidity of the second component, the preload force can be locally increased in the region of the protrusion and of the depression. Furthermore, as a result of the protrusion, or of the depression, a larger surface area is provided, over which the preload force of the connecting arrangement can be distributed, wherein this larger surface area can be exploited particularly advantageous by surface contact of the second component. Extensive contact between the first component and the second component by way of the connecting arrangement is achieved in this case by sectional deformation of the second component, which can be coordinated with the contours of the protrusion and of the depression by the deformation.

According to a further exemplary configuration of the connecting arrangement, the screw is arranged, in the fitted state, on a vehicle seat, and provision can be made in particular for at least the first component to be part of the vehicle seat, in particular part of a structural component, manufactured from sheet metal, of the vehicle seat. The second component can likewise be a structural component, manufactured from sheet metal, of the vehicle seat, or an add-on part manufactured from sheet metal or some other material.

The object is also achieved according to the invention by a vehicle seat having a first component and a second component which have been fixed by means of a connecting arrangement according to the invention. As a result, the vehicle seat can advantageously be manufactured, with a saving in weight, by means of the high-strength connecting arrangement.

The object is also achieved according to the invention by a method for producing a connecting arrangement according to the invention, which is characterized by the use of a drawing process and/or stamping process to form the counterpart connecting piece in the first component.

As a result of the use of a drawing process and/or stamping process to form the counterpart connecting piece, in particular the collar and the depression in the supporting face, the advantage is achieved that the counterpart connecting piece can already be produced during the manufacturing thereof, preferably in the context of a forming process which gives the counterpart connecting piece a desired final shape, without further necessary complicated work steps and machining operations. In this way, it is advantageously possible not only to save time in the manufacturing of the counterpart connecting piece, but also to minimize the number of manual operations to be carried out by operators of the manufacturing machines. As a result of the latter, it is also possible in particular to advantageously minimize the number of possible sources of error in the manufacturing of the counterpart connecting piece.

The object is also achieved according to the invention by a method for connecting a first component to a second component by means of the above-described connecting arrangement, wherein the second component is fixed by the screw being screwed into the first component.

Furthermore, in this case, the second component can experience a sectional deformation as a result of the protrusion on the screw head and the depression in the supporting face.

Alternatively, the second component can have a preformed deformation which is introduced into the depression in the first component, in order to align the second component relative to the first component, during the assembly of the connecting arrangement.

Before configurations of the invention are described in more detail in the following text using drawings, it should first of all be noted that the invention is not limited to the described components or the described method steps. Furthermore, the terminology which is used also does not represent a limitation, but rather has merely exemplary character. Where the singular is used in the following text in the description and the claims, the plural is also included in each case, as long as the context does not explicitly preclude this.

The invention is explained in more detail in the following text by way of an advantageous exemplary illustrated in the figures. The various features of novelty, which characterize the invention, are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional illustration of a possible configuration of a connecting arrangement in an assembled state; and

FIG. 2 is a side illustration of a vehicle seat according to the invention.

### DESCRIPTION OF THE PREFERRED EMBODIMENTS

Referring to the drawings, the connecting arrangement has a screw 1 with a screw head 10 and a threaded shank 11 having an external thread 12. Furthermore, the connecting arrangement has a first component 2 with a counterpart connecting piece 20, wherein the counterpart connecting piece 20 has a supporting face 21 and a collar 23. A depression 22 encircling the collar 23 is formed in the supporting face 21 of the first component 2. An encircling protrusion 14 is arranged on an underside 13, facing the collar 23, of the screw head 10. In a fitted state of the screw 1, the protrusion 14 is operatively connected to the depression 22 in the supporting face 21 of the counterpart connecting piece 20, in particular with the second component 3 interposed. Furthermore, a receptacle 15 is arranged in the screw head 10, said receptacle being provided to receive and/or to be connected to a screwing-in device (not illustrated) for the screw 1. The receptacle 15 can be embodied for example in a hexagonal manner.

The counterpart connecting piece 20 has been manufactured in the first component 2 by means of a drawing process and/or a stamping process. In the present case, an internal thread 24 is also arranged in the collar 23, said internal thread 24 cooperating with the external thread 12 on the screw 1. Alternatively, provision can be made for the collar 23 to be embodied without a thread and for the screw 1 to have a corresponding self-tapping external thread 12 and accordingly to cut automatically into the smooth surface of the inner wall of the collar 23 and to be braced therein when the screw 1 is fitted. In order to connect the second component 3 to the first component 2, the screw 1 has been passed through a through-opening 30 in the second component 3 and screwed into the internal thread 24 of the collar 23.

Provision is furthermore made for the protrusion 14 to be located opposite the depression 22 in the supporting face 21, in particular to correspond to the supporting face 21 of the counterpart connecting piece 20.

The counterpart connecting piece 20 is in the present case a component manufactured from a metal sheet, in particular a shaped part.

The protrusion 14 is configured in an encircling manner and extends coaxially with an axis A of the screw 1, which corresponds to the rotation axis of the substantially cylindrical threaded shank 11. Similarly, the illustrated protrusion 14 is configured in a continuous manner in the encircling direction, but can alternatively also be interrupted in the encircling direction.

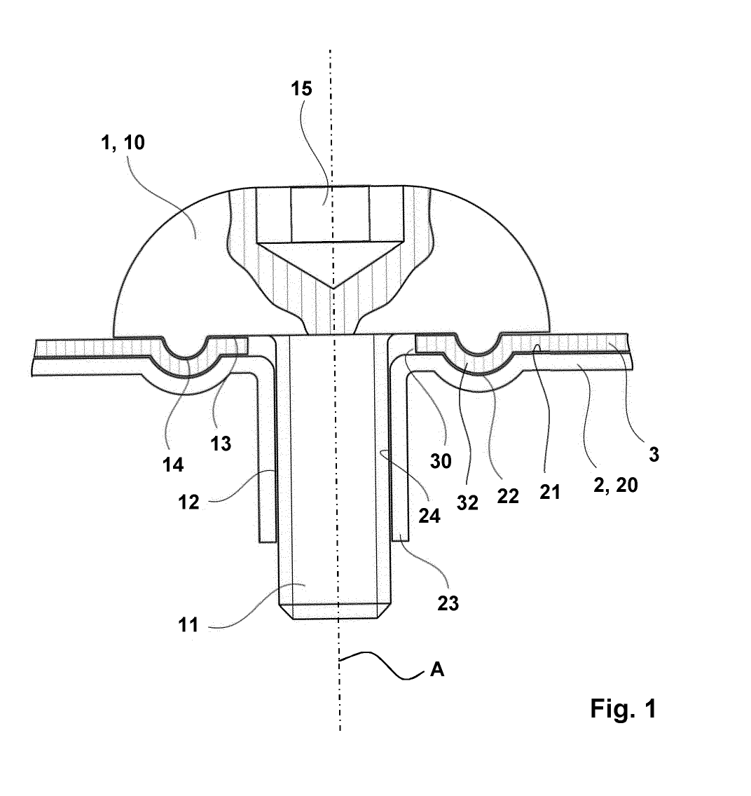

It can furthermore be seen from FIG. 1 that the protrusion 14 on the underside 13 of the screw head 10 interacts with the depression 22 in the supporting face 21 of the counterpart connecting piece 20 in the fitted state of the screw 1, or is operatively connected to the depression 22 such that a second component 3 to be fixed by means of the connecting arrangement is able to be pressed into the depression 22 by a force exerted locally by the protrusion 14 in the region of the depression 22. In this case, the second component 3 experiences a sectional deformation 32 as a result of the interaction of the protrusion 14 on the screw head 10 and the depression 22 in the supporting face 21. Preferably, the second component 3 has an at least partially preformed deformation 32, which has been introduced into the depression 22 in the first component 2, in order to orient the second component 3 relative to the first component 2, during the assembly of the connecting arrangement. The deformation 32, together with the force exerted on the second component 3 by the clamping between the screw head 10 and the supporting face 21, brings about a force-fitting connection between the first component 2 and the second component 3, and also a form-fitting connection between the protrusion 14, the deformation 32 and the depression 22.

Furthermore, the second component 3 to be fixed by means of the connecting arrangement is clamped between the screw head 10 and the supporting face 21.

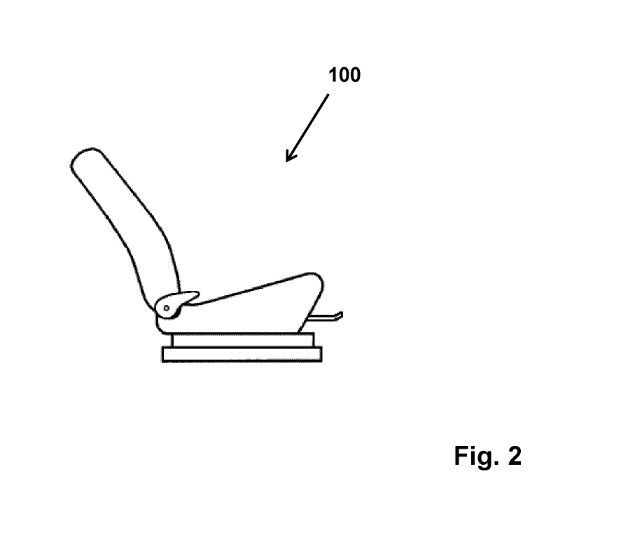

The vehicle seat 100 shown in FIG. 2 has a first component 2 and a second component 3, which have been fixed by means of a connecting arrangement according to the invention and preferably connected together. The connecting arrangement is not illustrated explicitly for illustration reasons. For example, the second component 3 can be a cover for the backrest of the vehicle seat 100, which is fixable to a structural part of the backrest of the vehicle seat as a first component 2 by means of a screw 1.

Although the invention has been described in detail in the drawings and the above description, the descriptions should be understood as being illustrative and exemplary and nonlimiting. In particular, the choice of the proportions, shown in the drawings, of the individual elements should not be interpreted as necessary or restrictive. Furthermore, the invention is, in particular, not limited to the exemplary embodiment explained. Further variants of the invention and the realization thereof can be gathered by a person skilled in the art from the above disclosure, the figures and the claims.

While specific embodiments of the invention have been shown and described in detail to illustrate the application of the principles of the invention, it will be understood that the invention may be embodied otherwise without departing from such principles.

1. A connecting arrangement comprising:
a first component
a second component; and
a screw with a screw head and a threaded shank having an external thread, wherein the first component has a counterpart connecting piece with a supporting face and a collar, wherein a depression encircling the collar is formed in the supporting face, wherein a protrusion is arranged on an underside of the screw head, facing the collar, wherein the protrusion is operatively connected to the depression in the supporting face of the counterpart connecting piece in a fitted state of the screw, with the second component interposed between the screw head and the first component to connect the first component to the second component.

2. The connecting arrangement as claimed in claim 1, wherein the counterpart connecting piece is manufactured in the first component by means of a drawing process and/or a stamping process.

3. The connecting arrangement as claimed in claim 1, wherein the second component is fixable between the screw head and the supporting face.

4. The connecting arrangement as claimed in claim 3, wherein the second component is fixable by the screw being screwed into the first component.

5. The connecting arrangement as claimed in claim 1, wherein the counterpart connecting piece is manufactured from a metal sheet.

6. The connecting arrangement as claimed in claim 1, wherein, in the fitted state of the screw, the protrusion is located opposite the depression in the supporting face.

7. The connecting arrangement as claimed in claim 1, wherein the protrusion extends coaxially with an axis of the screw.

8. The connecting arrangement as claimed in claim 1, wherein the protrusion is interrupted in an encircling direction.

9. The connecting arrangement as claimed in claim 1, wherein the protrusion extends continuously in an encircling direction.

10. The connecting arrangement as claimed in claim 1, wherein the protrusion is able to be screwed into a deformation of the second component when the deformation of the second component engages in the depression in the first component.

11. A vehicle seat comprising:
a first component;
a second component; and
a screw with a screw head and a threaded shank having an external thread, wherein the first component has a counterpart connecting piece with a supporting face and a collar, wherein a depression encircling the collar is formed in the supporting face, wherein a protrusion is arranged on an underside of the screw head, facing the collar, wherein the protrusion is operatively connected to the depression in the supporting face of the counterpart connecting piece in a fitted state of the screw, with the second component interposed between the screw head and the first component to form a connecting arrangement connecting the first component to the second component.

12. A method producing a connecting arrangement, the method comprising the steps of:
providing a first component;
providing a second component;
providing a screw with a screw head and a threaded shank having an external thread, wherein the first component has a counterpart connecting piece with a supporting face and a collar, wherein a depression encircling the collar is formed in the supporting face, wherein a protrusion is arranged on an underside of the screw head, facing the collar, wherein the protrusion is operatively connected to the depression in the supporting face of the counterpart connecting piece in a fitted state of the screw, with the second component interposed between the screw head and the first component to connect the first component to the second component; and
forming the counterpart connecting piece in the first component with by drawing.

13. A connecting method comprising:
providing a first component;
providing a second component;
providing a screw with a screw head and a threaded shank having an external thread, wherein the first component has a counterpart connecting piece with a supporting face and a collar, wherein a depression encircling the collar is formed in the supporting face, wherein a protrusion is arranged on an underside of the screw head, facing the collar, wherein the protrusion is operatively connected to the depression in the supporting face of the counterpart connecting piece in a fitted state of the screw, with the second component interposed between the screw head and the first component to connect the first component to the second component; and
fixing the second component by the screw being screwed into the first component.

14. The method as claimed in claim 13, wherein the second component experiences a sectional deformation as a result of the protrusion on the screw head and the depression in the supporting face.

15. The method as claimed in claim 13, wherein the second component has an at least partially preformed deformation which is introduced into the depression in the first component, to align the second component relative to the first component, during the assembly of the connecting arrangement.
